(19) United States
(12) Patent Application Publication
(10) Pub. No.: US 2023/0008369 A1
(43) Pub. Date: Jan. 12, 2023

(54) Customized Online Bookstore

(71) Applicants: Radhika BAJAJ, Fairfax Station, VA (US); Sunil BAJAJ, Fairfax Station, VA (US); Laurie R. ROTHENBERG, Annandale, VA (US)

(72) Inventors: Radhika BAJAJ, Fairfax Station, VA (US); Sunil BAJAJ, Fairfax Station, VA (US); Laurie R. ROTHENBERG, Annandale, VA (US)

(73) Assignee: Ensemble, Inc., Fairfax Station, VA (US)

(21) Appl. No.: 17/652,252

(22) Filed: Feb. 23, 2022

Related U.S. Application Data
(60) Provisional application No. 63/130,003, filed on Dec. 23, 2020.

(51) Int. Cl. G06Q 30/06

(52) U.S. Cl. CPC G06Q 30/0641; G06Q 30/0631

(57) ABSTRACT

A system and method for providing a customized bookstore for a school including creating an online bookstore associated with a school based on a catalog including book identifiers; customizing a look and feel of the online bookstore to identify the school; populating lists wherein each list of the lists includes a category, a donation flag and a booklist including a subset of book identifiers, where the lists include a school booklist and a donation booklist; receiving an order including a shipping address, a selected category and at least one book identifier from the booklist associated with the selected list identifier; and shipping an order confirmation indicating, for each of the books associated with the least one book identifier, a respective category.

### CROSS-REFERENCE TO RELATED APPLICATIONS AND INCORPORATION BY REFERENCE

The present application claims the benefit under 35 U.S.C. 119(e) of U.S. Provisional Application Ser. No. 63/130,003, filed Dec. 23, 2021, which is incorporated herein by reference in its entirety.

### FIELD

The present invention is related to simplified online retail sales and more specifically to online sales of trade books and related materials for an organization such as a school from pre-kindergarten to high school and organizations.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings disclose providing online bookstores to distribute products including books recommended by organizations operating a customized bookstore per organization. The organization may be associated with book drives, bookfairs, categories, teachers, and the like. A consumer may identify products starting with the organization, and then further refine the product list by book drives, bookfairs, categories, teachers, and the like. The consumer may designate that the purchased products be intended for the consumer, a third parties with a need (for example, students in need), a teacher (for example, for a classroom library using a teacher wishlist), an organization (for example, for an organization library using an organization wishlist), or the like. Sales may be managed per bookstore with a third-party responsible for maintaining inventory, adjusting products available for sale, and order fulfillment. The organization may receive a portion of the moneys for the sold products.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for providing a customized bookstore for a school including creating an online bookstore associated with a school based on a catalog including book identifiers; customizing a look and feel of the online bookstore to identify the school; populating lists wherein each list of the lists includes a category, a donation flag and a booklist including a subset of book identifiers, where the lists include a school booklist and a donation booklist; receiving an order including a shipping address, a selected category and at least one book identifier from the booklist associated with the selected list identifier; and shipping an order confirmation indicating, for each of the books associated with the least one book identifier, a respective category. Other embodiments of this aspect include corresponding computer systems, apparatus, and computer programs recorded on one or more computer storage devices, each configured to perform the actions of the methods.

Implementations may include one or more of the following features. The method may include sending, when the donation flag is not set, the books associated with the at least one book identifier to a shipping address of the order; and redirecting, when the donation flag is set, the books associated with the at least one book identifier to a donee address. The method where the customizing includes displaying one or more of a logo, a color scheme, a message, or a graphic associated with the school/organization. The method where the catalog includes a plurality of catalogs. The method where the donation booklist includes one of more of a book drive booklist and a teacher booklist. The method where the lists comprise one or more lists for a subject, a grade, an age, and a bookfair. The method where the creating generates a canonical Uniform Resource Locator (URL) for the created online bookstore. The method where the selected category includes a first category where the donation flag is set and a second category where the donation flag is not set. The method where a selected list of the lists is populated by a teacher. The method where a respective category of a selected list of the lists is set by a teacher. The method where a category includes categories arranged in a hierarchy. The method where more than one of the lists comprises one of the book identifiers. Implementations of the described techniques may include hardware, a method or process, or computer software on a computer-accessible medium.

Additional features will be set forth in the description that follows, and in part will be apparent from the description, or may be learned by practice of what is described.

### DRAWINGS

The patent or application file contains at least one drawing executed in color. Copies of this patent or patent application publication with color drawing(s) will be provided by the Office upon request and payment of the necessary fee.

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a system servicing various types of users and their associated activities according to some embodiments.

FIG. 2 illustrates operations associated with a coordinator according to some embodiments.

FIG. 3 illustrates operations associated with a teacher according to some embodiments.

FIG. 4 illustrates a method for providing a customized bookstore for a school according to various embodiments.

FIG. 5 illustrates an exemplary landing page for an online bookstore according to some embodiments.

FIG. 6 illustrates an exemplary page with an expanded view of the top-level category book drive according to some embodiments.

FIG. 7 illustrates an exemplary shopping cart including an order according to some embodiments.

FIG. 8 illustrates booklist management according to various embodiments.

FIG. 9 illustrates a purchase report including a send thank you capability according to various embodiments.

FIG. 10 illustrates a purchase report including proceeds for an organization according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The present teachings disclose a customized bookstore for organizations, such as, schools, classes within schools, businesses, accreditation bodies, associations, training academies or the like. The online bookstore may be displayed with a customized look and feel including a color scheme, a font, a logo, an overview or the like for the organization. Each bookstore may support a variety of roles for users, for example, coordinator, teacher, student, parent, consumer, donee or the like. Each bookstore may include a book selection for the store, lists/carousels with customized book selection for a respective list, fund drives, book fairs, wishlists, recommended reading or the like. The bookstore or carousel may be populated with merchandise including books from many repositories.

Sales may be per bookstore with third-party fulfillment of orders. The third-party may be responsible for maintaining the bookstores inventory and fulfilling orders therefrom. The bookstore may be Adjustable throughout the year. The changes may be based on current events and as an audience of the bookstore changes.

In the present description, the online bookstore is exemplified for school. However, this exemplar is not limiting. Online bookstores may be used by other organizations.

The online bookstore may have a landing page (see for example FIG. 5) that displays various booklists by categories. The categories may be hierarchical. Exemplary top-level categories may include school wishlists, recommended reading, book drives, book fairs or the like. Within each top-level category may include sub-categories. Each category, including top-level, may be flagged as a donation booklist or a non-donation booklist. In one example, the top-level category school wishlists may be a donation booklist that includes booklists identified by one or more of a teacher, the school library and the like. Further, the top-level category recommended reading may be a non-donation booklist with exemplary sub-categories like 1^{st} grade, 2^{nd} grade, picture book favorites, workbooks, foreign language and the like. The top-level categories book drives and/or book fairs may be used to group various book drives and/or fairs. The categories may include categories for items other than books. The booklists may include items other than books that are available in a distributor's catalog. For example, categories such as fun stuff, cash donations, robots, toys, pencils and pens and the like may be added to a bookstore's landing page. In some embodiments, a dynamic category such as “Best Sellers” may be added, where the contents of the dynamic category are updated by the system without coordinator intervention.

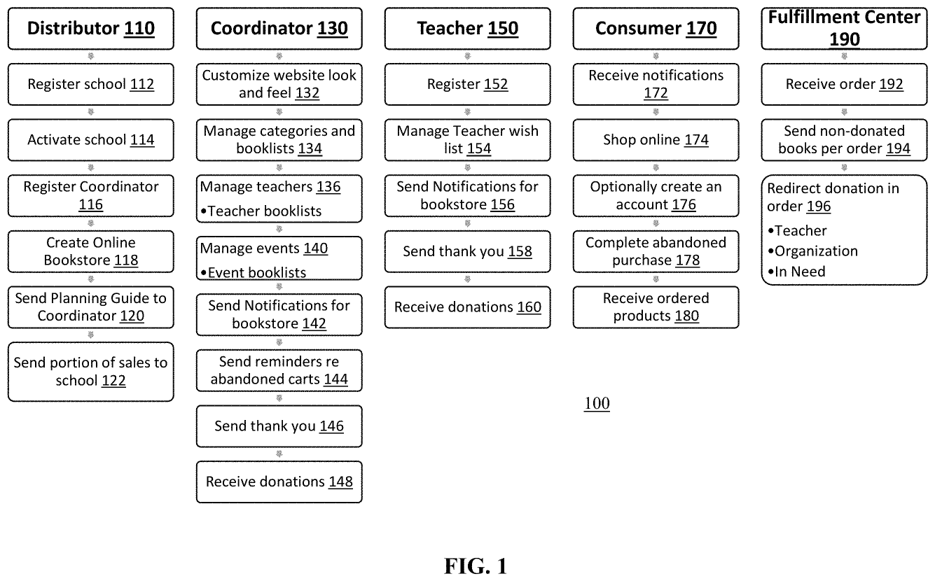

FIG. 1 illustrates a system servicing various types of users and their associated activities according to some embodiments.

A system 100 may service various types of users including a distributor 110, a coordinator 130, a teacher 150, a consumer 170 and a fulfillment center 190. The distributor 110 may register a school at operation 112. Registration may include registration information verification and a sales agreement or contract between the distributor 110 and the school. The system 100 may include waiting for signed copies of the contract prior activating the school's online bookstore at operation 114. The distributor 110 may host and operate online bookstore, have a catalog of products including books for sale, may be a fulfillment center, be a retailer, be a wholesaler or the like. The distributor 110 may activate a school at operation 114. The distributor 110 may Register a Coordinator at operation 116. The distributor 110 may Create an Online Bookstore at operation 118. The distributor 110 may Send a Planning Guide to the Coordinator at operation 120. The distributor 110 may send a portion of sales to the school at operation 124. An exemplary distributor 110 and fulfillment center 190 is Bookworm Central of Chantilly, Va.

The Coordinator 130 may be a school employee. The coordinator 130 may be the bookstore manager. The coordinator 130 may Manage the website look and feel at operation 132. The coordinator 130 may Manage categories and booklists at operation 134. The managing 134 may include creating lists by subject, age, grade, recommendation, teacher wishlists and the like. The coordinator 130 may Manage teachers, including teacher booklists or wishlists, at operation 136. The coordinator 130 may Manage events of the bookstore at operation 140. The managing 140 include may include managing Event booklists, donees, duration of the event or the like. The coordinator 130 may Send Notifications for the bookstore at operation 142. The coordinator 130 may Send reminders regarding abandoned carts to the consumer 170 at operation 144. The system 100 may notify the coordinator 130 when an order includes a donation. The coordinator 130 may send a thank you to the consumer 170 at operation 146. The coordinator 130 may manage a school booklist as a donation booklist with the school library as the donee. The coordinator 130 may manage a book drive as a donation booklist with the intention of distributing the books to kids in need. The coordinator 130 may receive donations meant for the school at-large at operation 148.

The Teacher 150 may register with the online bookstore at operation 152. The teacher 150 may manage a teacher wishlist at operation 154. The teacher wishlist may be a donation booklist with the teacher as a donee. In some embodiments, the teacher may use the teacher wishlist for adding to a classroom library. The teacher 150 may send notifications related to events or additions to the bookstore at operation 156. The system 100 may notify the teacher 150 when an order includes a donation. The teacher 150 may send a thank you at operation 158, for example, to a consumer 170 sending a donation to the teacher 150. The teacher 150 may receive the donations at operation 160.

A consumer 170 may or may not register with the system 100 to browse the online bookstore or to order books listed therein. The consumer 170 may receive notifications at operation 172, for example, from the teacher 150, the coordinator 130, the distributor 110 or the like. The consumer 170 may shop online at operation 174. The consumer 170 may optionally create an account at operation 176. The consumer 170 may complete an abandoned purchase at operation 178. The consumer 170 may receive one or more ordered products at operation 180. The consumer 170 may include the coordinator 110, the teacher 150, students, parents of students, or other third parties.

A Fulfillment Center 190 may be used to ship products/books in an order. The distributor 110 may be the fulfillment center 190. The fulfillment center 190 may receive an order at operation 192. The fulfillment center 190 may send one or more non-donated books per the order at operation 194. The fulfillment center 190 may redirect a donation in the order at operation 196. The donee associated with the donation may include one or more of a Teacher, an Organization, or an In Need individual.

Each bookstore may include a customized item selection for the store, lists/carousels each with customized item selection for a respective carousel, wishlist for teacher/leader, fund drives, book fairs, wishlists, recommended reading or the like. The bookstore or carousel may be populated with merchandise including books from many repositories. Item selection for the bookstore, carousel, wishlist, book fair, book drive or the like may or may not overlap.

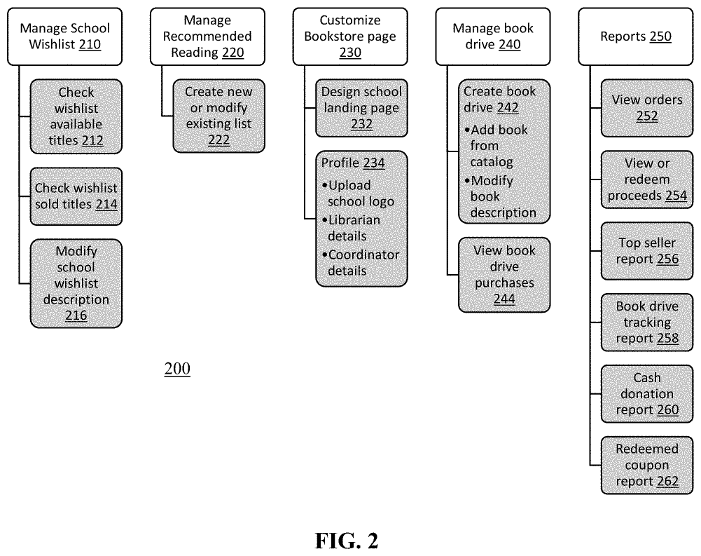

FIG. 2 illustrates operations associated with a coordinator according to some embodiments.

A coordinator may manage a school wishlist at operation 210 with operations such as Check wishlist available titles at operation 212, Check wishlist sold titles at operation 214 and Modify school wishlist description at operation 216. The coordinator may Manage Recommended Reading category at operation 220 with operations such as Create new or modify existing list at operation 222. The coordinator may Customize the Bookstore page at operation 230 with operations such as Design school landing page at operation 232, Profile (school's) at operation 234. Operation 232 may include providing a basic school message, setting colors (header, footer, background etc.), selecting a template, choosing lists to be displayed on the landing page, providing an order for content, and the like. Operation 234 may include uploading a school logo, providing Librarian details, and providing Coordinator details. The coordinator may Manage a book drive at operation 240 with operations such as Create book drive at operation 242 (Add book from catalog, Modify book description etc.) and View book drive purchases at operation 244. The coordinator may obtain Reports at operation 250 with operations such as View orders at operation 252, View or redeem proceeds at operation 254, Top seller report at operation 256, Book drive tracking report at operation 258, Cash donation report at operation 260, and Redeemed coupon report at operation 262. In some embodiments, the coordinator may order books (not shown) from the bookstore. In some embodiments, the coordinator may perform operations available to a teacher or a consumer.

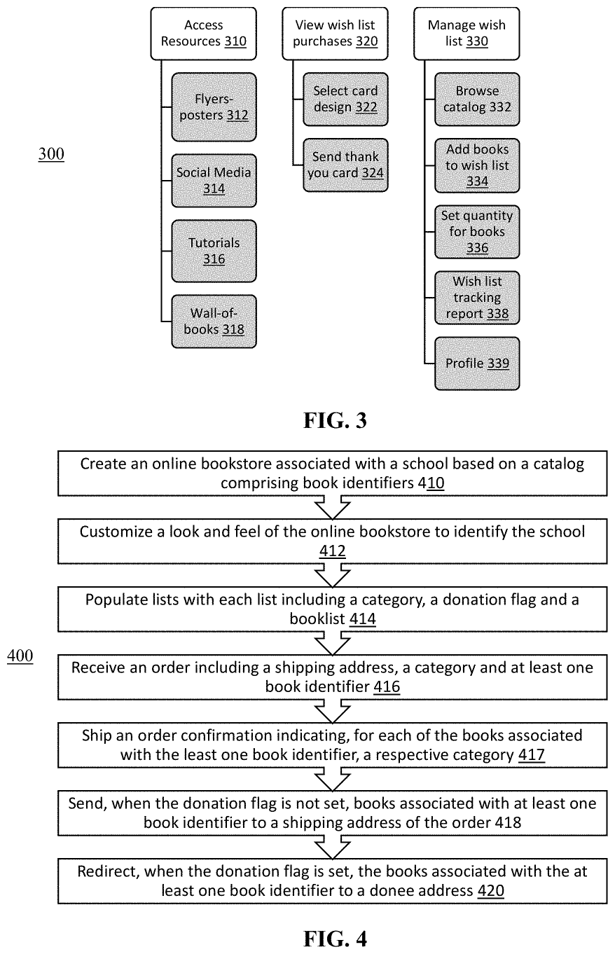

FIG. 3 illustrates operations associated with a teacher according to some embodiments. A teacher may access resources at operation 310 including Flyers-posters 312, Social Media 314, Tutorials 316, and Wall-of-books 318. The teacher may View wish list purchases at operation 320 with operations such as Select card design 322, and Send thank you card 324. The teacher may Manage wish list at operation 330 with operations such as Browse catalog 332, Add books to wish list 334, Set quantity for books 336, Wish list tracking report 338, and Profile (teacher's) 339.

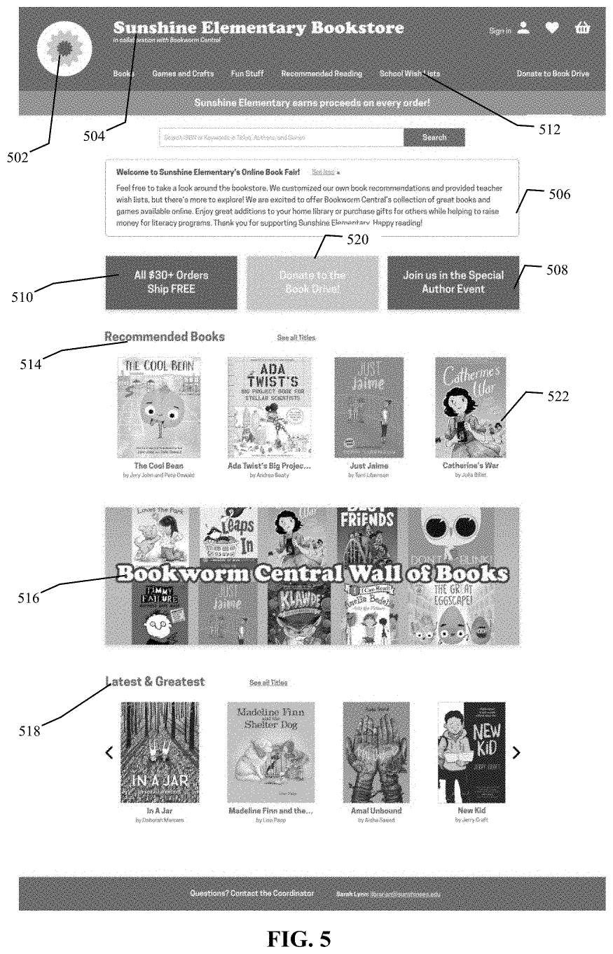

FIG. 4 illustrates a method for providing a customized bookstore for a school according to various embodiments.

FIG. 4 illustrates a method 400 for providing a customized bookstore for a school. The method 400 may include operation 410 to Create an online bookstore associated with a school based on a catalog comprising book identifiers. The method 400 may include operation 412 to Customize a look and feel of the online bookstore to identify the school. The method 400 may include operation 414 to Populate lists with each list including a category, a donation flag and a booklist. The method 400 may include operation 416 to Receive an order including a shipping address, a category and at least one book identifier. The method 400 may include operation 417 to ship an order confirmation indicating, for each of the books associated with the least one book identifier, a respective category. The method 400 may include operation 418 to Send, when the donation flag is not set, books associated with at least one book identifier to a shipping address of the order. The method 400 may include operation 420 to Redirect, when the donation flag is set, the books associated with the at least one book identifier to a donee address 420.

FIG. 5 illustrates an exemplary landing page for an online bookstore according to some embodiments.

FIG. 5 illustrates an exemplary landing page for an online bookstore including a logo 502, a name 504, a message 506, an event message 508, a special 510, a list of top-level categories 512, a top-list category 514 with a first style followed by a graphic booklist 522, a top-list category 516 with a second style illustrating a booklist, a top-list category 518 and a link 520 to one or more book drives.

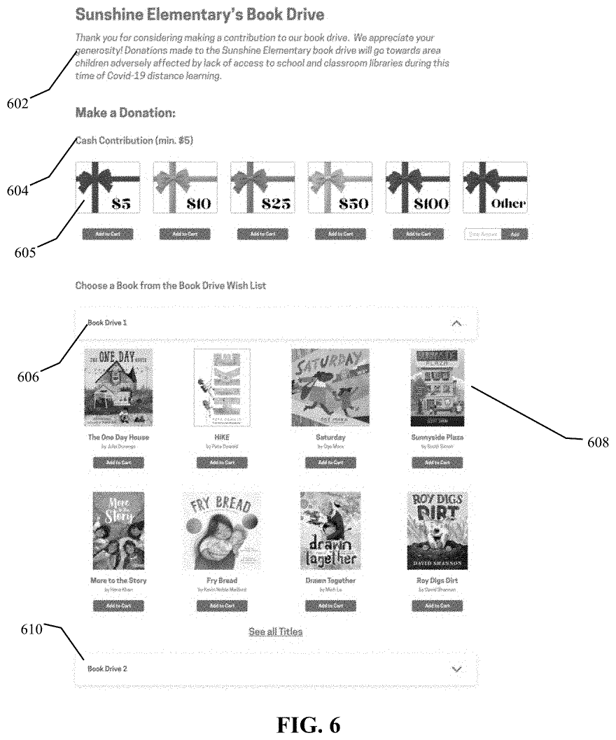

FIG. 6 illustrates an exemplary page with an expanded view of the top-level category book drive according to some embodiments.

FIG. 6 illustrates a page with an expanded view of the top-level category book drive including a book-drive message 602, a category cash contribution 604 followed by an item list 605 for the category cash contribution 604, a category book drive 1 606, a graphic booklist 608 for category book drive 601 and a category book drive 2 610.

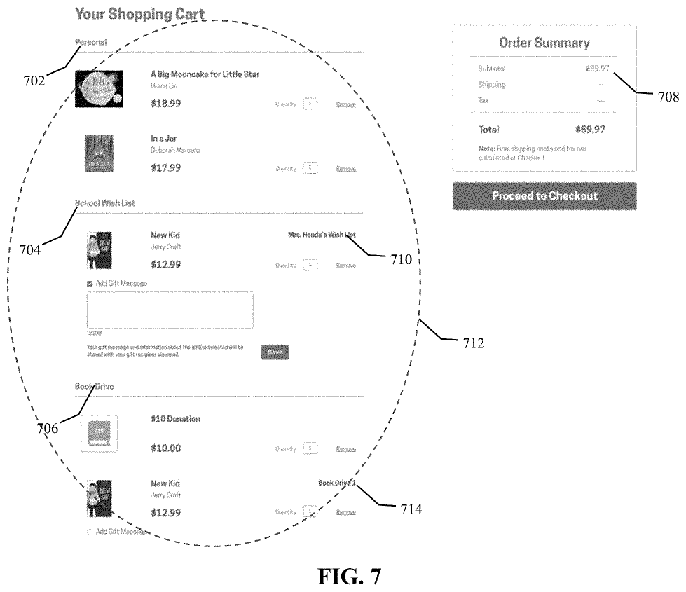

FIG. 7 illustrates an order confirmation including an order summary according to some embodiments.

FIG. 7 illustrates an order confirmation including an order summary 708, and an item summary 712. The item summary 712 identifies a non-donation category 702 and associated ordered books, a donation top-level category 704 and associated ordered book with a sub-category 710, and a top-level category 706 with a sub-category 714.

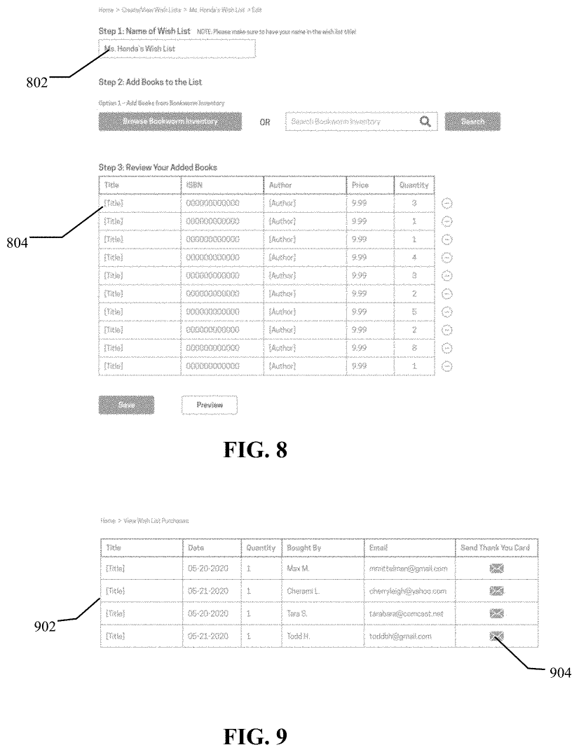

FIG. 8 illustrates booklist management according to various embodiments.

FIG. 8 illustrates booklist management including a category name 802 and a list of items 804 to be associated with the category.

FIG. 9 illustrates a purchase report including a send thank you capability according to various embodiments.

FIG. 9 illustrates a purchase report 902 including a send thank you capability 904.

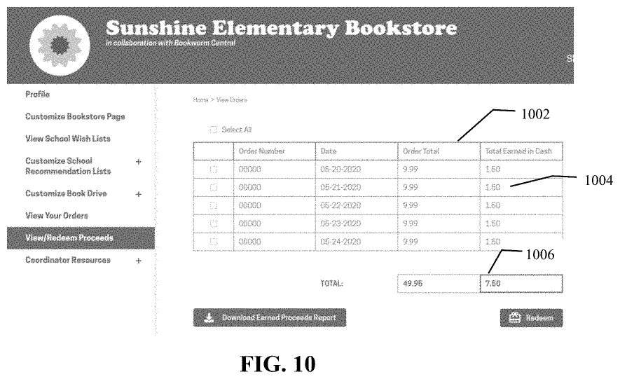

FIG. 10 illustrates a purchase report including proceeds for an organization according to various embodiments.

FIG. 10 illustrates a purchase report 1004 including proceeds for an item 1004 and total proceeds 1006.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A non-transient computer-readable storage medium having instructions embodied thereon, the instructions being executable by one or more processors to perform a method for providing a customized bookstore for a school, the method comprising:
creating an online bookstore associated with a school based on a catalog comprising book identifiers;
customizing a look and feel of the online bookstore to identify the school;
populating lists wherein each list of the lists comprises a category, a donation flag and a booklist comprising a subset of book identifiers, wherein the lists comprise a school booklist and a donation booklist;
receiving an order comprising a shipping address, a selected category and at least one book identifier from the booklist associated with the selected list identifier; and
shipping an order confirmation indicating, for each of the books associated with the least one book identifier, a respective category.

2. The method of claim 1, further comprising sending, when the donation flag is not set, the books associated with the at least one book identifier to a shipping address of the order; and redirecting, when the donation flag is set, the books associated with the at least one book identifier to a donee address.

3. The method of claim 1, wherein the customizing comprises displaying one or more of a logo, a color scheme, a message, or a graphic associated with the school.

4. The method of claim 1, wherein the catalog comprises a plurality of catalogs.

5. The method of claim 1, wherein the donation booklist comprises one of more of a book drive booklist and a teacher booklist.

6. The method of claim 1, wherein the lists comprise one or more lists for a subject, a grade, an age, and a bookfair.

7. The method of claim 1, wherein the creating generates a canonical Uniform Resource Locator (URL) for the created online bookstore.

8. The method of claim 1, wherein the selected category comprises a first category where the donation flag is set and a second category where the donation flag is not set.

9. The method of claim 1, wherein a selected list of the lists is populated by a teacher.

10. The method of claim 1, wherein a respective category of a selected list of the lists is set by a teacher.

11. The method of claim 1, wherein a category comprises categories arranged in a hierarchy.

12. The method of claim 1, wherein more than one of the lists comprises one of the book identifiers.
